(19) United States
(12) Patent Application Publication
(10) Pub. No.: US 2015/0142607 A1
(43) Pub. Date: May 21, 2015

(54) SHOPPING MIND READER

(71) Applicants: Cui Yang, Shanghai (CN); Cheng Qian, Shanghai (CN); Sail Chen, Shanghai (CN); Yaohui Chai, Shanghai (CN)

(72) Inventors: Cui Yang, Shanghai (CN); Cheng Qian, Shanghai (CN); Sail Chen, Shanghai (CN); Yaohui Chai, Shanghai (CN)

(21) Appl. No.: 14/085,683

(22) Filed: Nov. 20, 2013

(51) Int. Cl. G06Q 30/06

(52) U.S. Cl. CPC G06Q 30/0631; G06Q 30/0625
USPC 705/26.62

(57) ABSTRACT

Determining user intent based on current user query behavior comprising receiving from a client machine a plurality of signals indicating current user behavior when querying for items; tracking events of current user behavior indicated by the signals; and recommending items that the events indicate are items intended by the current user behavior. Seller performance may be and used in recommending the items. The recommended items may be ranked by a ranking algorithm that may comprise a boosted rank model algorithm that customizes ranking to each of a plurality of client machines.

### BACKGROUND

In a publication system such as an e-commerce system, search queries are received for different items when a user is surfing the publication system over a period of time. It may be difficult for a user who submits the queries to recall the comparisons the user may have made of similar items that satisfied the queries. It is desirable for a publication system to be able to provide the user with information that may help the user to recognize which of the compared items is, or is among, the user's favorite among the items compared.

### DESCRIPTION OF THE DRAWINGS

Some embodiments are illustrated by way of example and not limitation in the figures of the accompanying drawings:

FIG. 1 is a block diagram depicting a system for delivering queries to a publication system, according to an example embodiment.

FIG. 2 is a block diagram illustrating an environment for operating a mobile device, according to an example embodiment.

FIG. 3 is a block diagram illustrating a mobile device, according to an example embodiment.

FIG. 4 is a block diagram illustrating a network-based publication system for delivering search results, according to an example embodiment.

FIG. 5 is a block diagram illustrating applications useable as part of a publication system, according to an example embodiment.

FIG. 6 is a flow chart illustrating the data flow of an embodiment.

FIG. 7 is a diagrammatic representation of a machine in the example form of a computer system within which a set of instructions for causing the machine to perform any one or more of the methodologies discussed herein may be executed.

### DETAILED DESCRIPTION

The plethora of items available in today's e-commerce markets increases the difficulty for users to make purchase decisions as the evaluation of each alternative becomes cumbersome. Consequently, users tend to use a two-stage process to reach decisions. At a first stage, a user may typically screen a large set of available products or services (“items”) and identify a subset of the most promising alternatives. Subsequently, the user may evaluate these alternatives in more depth, perform relative comparisons across products on important attributes, and make a purchase decision. People may surf a publication system, such as an e-commerce system, for a long period of time to compare similar items. However, surfing is time consuming and people may easily forget the items, or the location of the items, queried. To remember advantages/disadvantages of each specific item queried can be even more difficult.

A publication system application, or widget, may be designed that, through recording how long a person spends on an item page and how often the person revisits this page, among other things, the widget can provide a hint to the user about which item is the user's favorite. The widget may also include logic to recommend relevant items or attributes tailored toward the user's preferences based on gradual learning of the user's view patterns, for example, the color of viewed necklaces. By the end of the surfing time, or by the end of the day, for example, a summary report can be generated by user's demand. This report may list the time spent, revisits as well as click stream on all the items that were viewed in this particular shopping experience, for example, based on the user's own behavior, such as what the user is looking for now instead based on historical data or profile data. For example, by operating on behavior like seller performance, user item views, user item watches, total or average time spent on a particular item, click stream and search path logging, clicks, revisits, page ups and page downs, comparisons can be made and a surprising underlying user intention might be detected. The report may provide a ranking of the user-viewed items and each item may be given a one to five star rating which is the outcome of a decision model. Users may then be able to make easier decisions with less effort.

Stated another way, a buyer may need a tool that can organize viewed items, promote the items the user is interested in and generally assist a user in making decisions. This may be done by providing a ranking of items that can reflect the buyer's degrees of interest, meet the buyer's expectation of qualities of items, and generally expedite the buyer's shopping process.

Some of the qualities that may reveal shopper intent are the time a shopper is engaged with an item in queries, the frequencies of interactions with items, and the depth and breadth with which the user analyses one or more items.

The intent analysis may be implemented, in one embodiment, by a widget that provides information to a user that may aid the user to recognize which item in one or more item queries is the user's favorite item.

### Example System

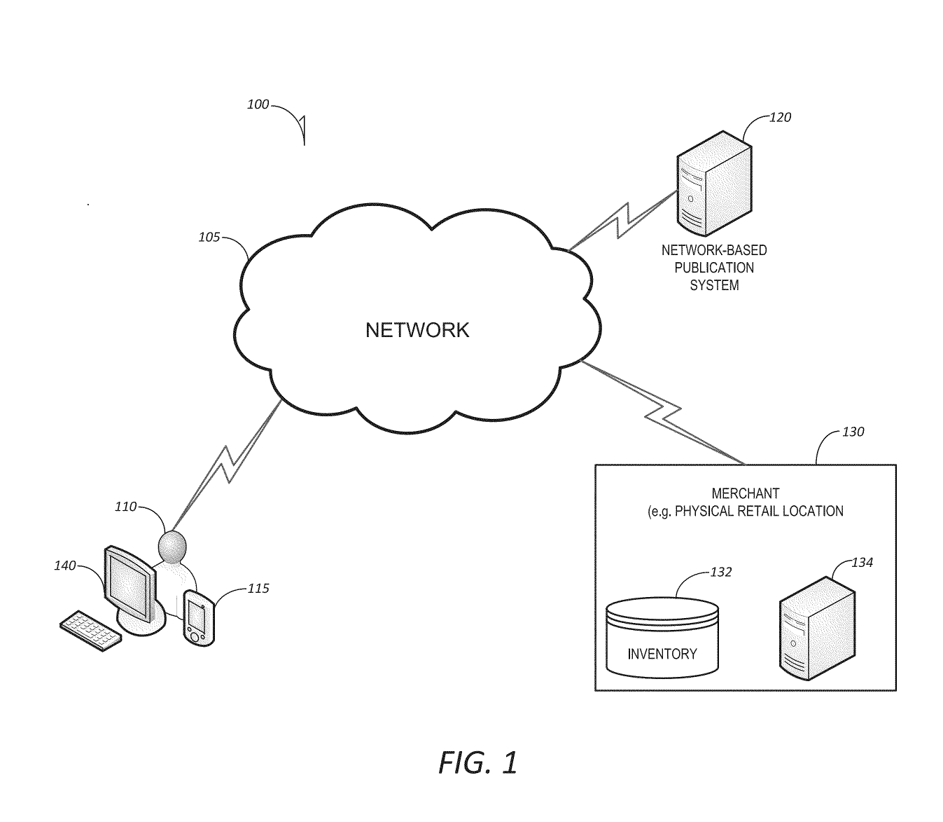

FIG. 1 is a block diagram depicting a system 100 for delivering search queries and results thereto, according to an example embodiment. The system 100 can include a user 110, a network-based publication system 120 with a search engine, and one or more merchants 130 (and merchant systems). In an example, the user 110 can connect to the network-based publication system 120 via a mobile or other device 115, 140 (e.g., desktop, laptop, smart phone, PDA, or similar electronic device capable of some form of data connectivity). The network-based publication system 120 will receive and process a query from the user's mobile device 115. Generally, location information specifying the physical or geographical location of the user 110 will be received with the query. For example, the mobile device 115 can include a GPS unit to inform the mobile device 115 of its location, such that the location information of the mobile device 115 can be shared with the network-based publication system 120. Other known techniques for deriving location information may be used with both mobile and non-mobile client computing devices, for example, such as desktop computers, etc. For instance, with some embodiments, the location information indicating the location of the user 110 may be explicitly specified by the user 110, for example, by the user 110 interacting with a map.

In an example, the merchant 130 can operate computer systems, such as an inventory system 132 or a POS system 134. The network-based publication system 120 can interact with any of the systems 132, 134 used by merchant 130 for operation of the merchant's retail or service business. In an example, the network-based publication system 120 can work with both POS system 134 and inventory system 132 to obtain access to inventory available at individual retail locations run by the merchant 130. This inventory information can be used in both generating product or service listings, and selecting and ordering search results served by the network-based publication system 120.

### Example Operating Environment

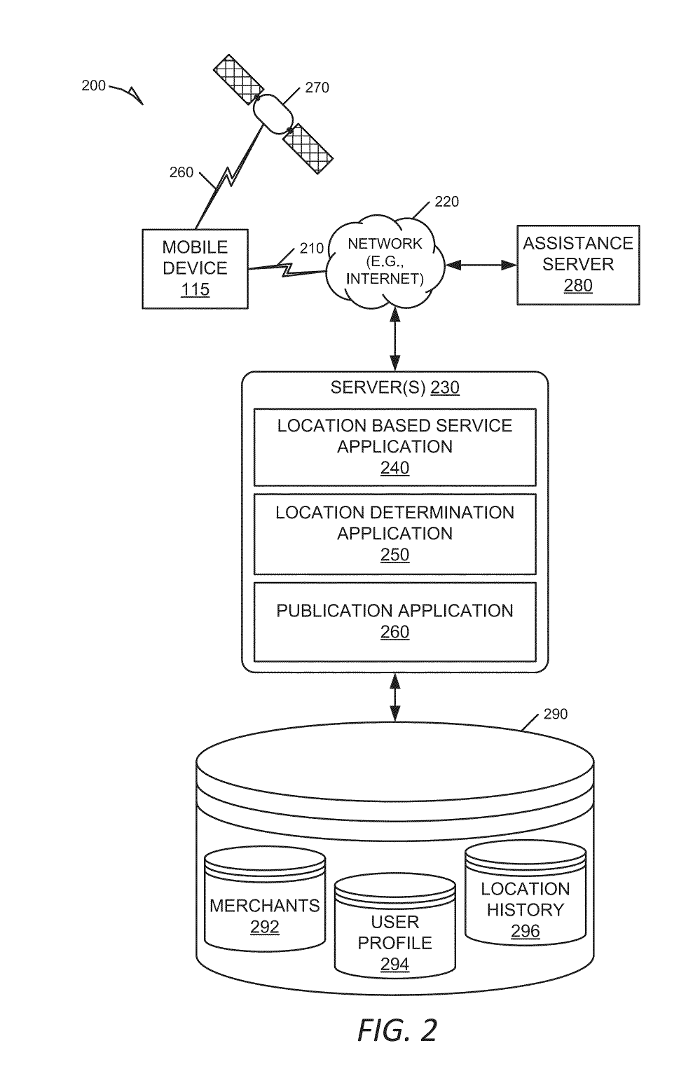

Generally, queries may be submitted to a publication system using either a stationery device or a mobile device. To illustrate queries submitted by a mobile device, FIG. 2 is a block diagram illustrating an environment 200 for operating a mobile device 115, according to an example embodiment. The environment 200 is an example environment within which methods of serving search results can be operated. In another example, environment 200 can host a navigated shopping service, which can also include the methods of serving search results discussed herein. The environment 200 can include a mobile device 115, a communication connection 210, a network 220, servers 230, a communication satellite 270, a merchant server 280, and a database 290. The servers 230 can optionally include location based service application 240, location determination application 250, publication application 260 with search engine 261, and payment application 265. The database 290 can optionally include merchant databases 292, user profile database 294, and/or location history database 296. The mobile device 115 represents one example device that can be utilized by a user to receive offers and share context information associated with the user. The mobile device 115 may be any of a variety of types of devices (for example, a cellular telephone, a PDA, a Personal Navigation Device (PND), a handheld computer, a tablet computer, a notebook computer, or other type of movable device). The mobile device 115 may interface via a connection 210 with a communication network 220. Depending on the form of the mobile device 115, any of a variety of types of connections 210 and communication networks 220 may be used.

In an example embodiment, the connection 210 may be Code Division Multiple Access (CDMA) connection, a Global System for Mobile communications (GSM) connection, or other type of cellular connection. Such connection 210 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 220 may include a cellular network that has a plurality of cell sites of overlapping geographic coverage, interconnected by cellular telephone exchanges. These cellular telephone exchanges may be coupled to a network backbone (for example, the public switched telephone network (PSTN), a packet-switched data network, LTE network, or other types of networks).

In another example, the connection 210 may be Wireless Fidelity (Wi-Fi, IEEE 802.11x type) connection, a Worldwide Interoperability for Microwave Access (WiMAX) connection, or another type of wireless data connection. In such an embodiment, the communication network 220 may include one or more wireless access points coupled to a local area network (LAN), a wide area network (WAN), the Internet, or other packet-switched data network.

In yet another example, the connection 210 may be a wired connection, for example an Ethernet link, and the communication network may be a LAN, a WAN, the Internet, or other packet-switched data network. Accordingly, a variety of different configurations are expressly contemplated.

A plurality of servers 230 may be coupled via interfaces to the communication network 220, for example, via wired or wireless interfaces. These servers 230 may be configured to provide various types of services to the mobile device 115. In an example embodiment, one or more servers 230 may execute location based service (LBS) applications 240, which intemperate with software executing on the mobile device 115, to provide LBSs to a user. LBSs can use knowledge of the device's location, and/or the location of other devices and/or retail stores, etc., to provide location-specific information, recommendations, notifications, interactive capabilities, and/or other functionality to a user. With some embodiments, the LBS operates in conjunction with the publication application 260 and search engine 261, in particular, to provide search results that are arranged based on the distance or travel time between a mobile device 115 (or other computer device) and a retail store. For example, an LBS application 240 can provide location data to a network-based publication system 120, which can then be used to arrange a set of search results, based on distance and/or travel time between two locations. Knowledge of the mobile device's location, and/or the location of other devices, may be obtained through interoperation of the mobile device 115 with a location determination application 250 executing on one or more of the servers 230. Location information may also be provided by the mobile device 115, without use of a location determination application such as application 250. In certain examples, the mobile device 115 may have some limited location determination capabilities that are augmented by the location determination application 250.

### Example Mobile Device

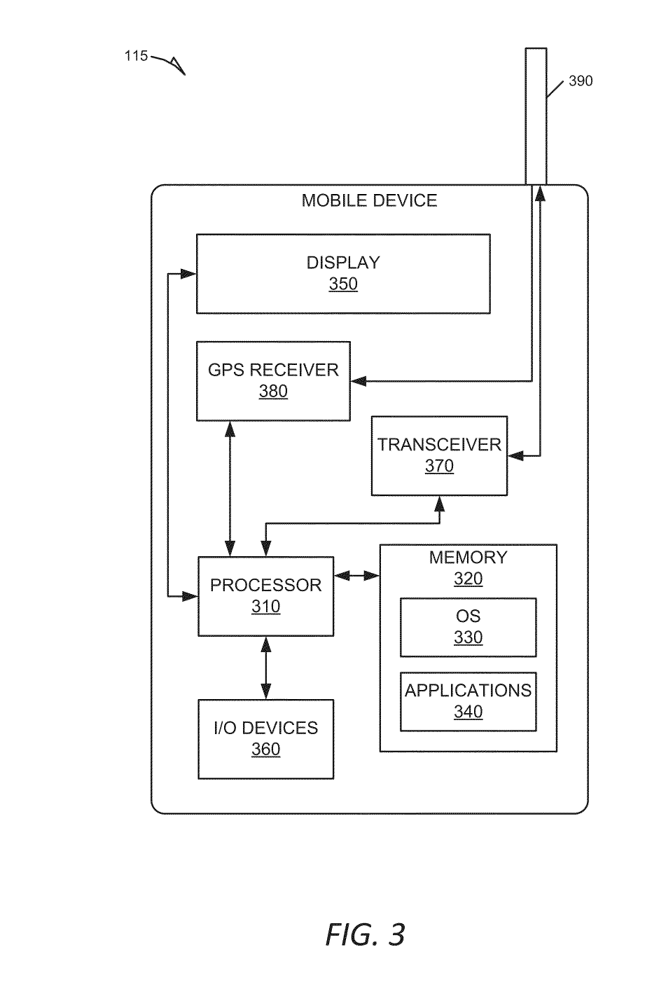

FIG. 3 is a block diagram illustrating the mobile device 115, according to an example embodiment. The mobile device 115 may include a processor 310. The processor 310 may be any of a variety of different types of commercially available processors suitable for mobile devices (for example, an XScale architecture microprocessor, a Microprocessor without Interlocked Pipeline Stages (MIPS) architecture processor, or another type of processor). A memory 320, such as a Random Access Memory (RAM), a Flash memory, or other type of memory, is typically accessible to the processor 310. The memory 320 may be adapted to store an operating system (OS) 330, as well as application programs 340, such as a mobile location enabled applications that may provide LBSs to a user. The processor 310 may be coupled, either directly or via appropriate intermediary hardware, to a display 350 and to one or more input/output (I/O) devices 360, such as a keypad, a touch panel sensor, a microphone, and the like. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 115. In this manner, the connection 210 with the communication network 220 may be established. Further, in some configurations, a GPS receiver 380 may also make use of the antenna 390 to receive GPS signals.

### Example Platform Architecture

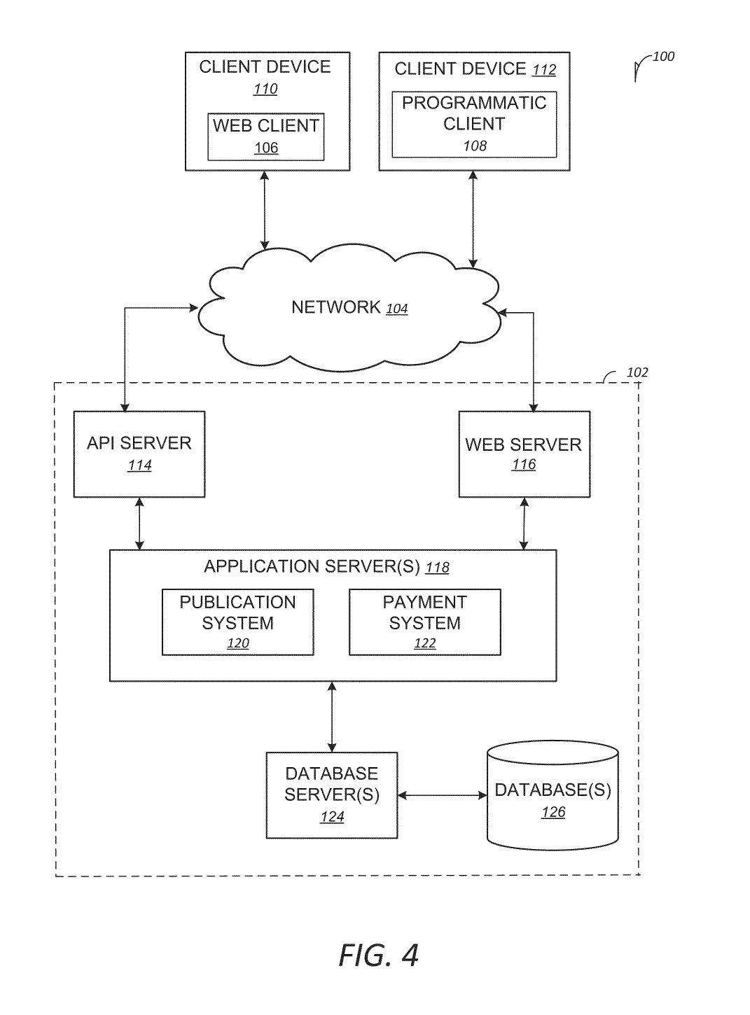

FIG. 4 is a network diagram depicting a network system 101, according to one embodiment, having a client-server architecture configured for exchanging data over a network. For example, the network system 101 may include a network-based publisher 102 where clients may communicate and exchange data within the network system 101. The data may pertain to various functions (e.g., online item purchases) and aspects (e.g., managing content) associated with the network system 101 and its users. Although illustrated herein as a client-server architecture as an example, other embodiments may include other network architectures, such as a peer-to-peer or distributed network environment.

A data exchange platform, in an example form of a network-based publisher 102, may provide server-side functionality, via a network 104 (e.g., the Internet, wireless network, cellular network, or a Wide Area Network (WAN)) to one or more clients. The one or more clients may include users that utilize the network system 101 and more specifically, the network-based publisher 102, to exchange data over the network 104. These transactions may include transmitting, receiving (communicating) and processing data to, from, and regarding content and users of the network system 101. The data may include, but are not limited to, content and user data such as feedback data; user profiles; user attributes; product attributes; product and service reviews; product, service, manufacture, and vendor recommendations and identifiers; social network commentary, product and service listings associated with buyers and sellers; auction bids; and transaction data, among other things.

In various embodiments, the data exchanges within the network system 101 may be dependent upon user-selected functions available through one or more client or user interfaces (UIs). The UIs may be associated with a client device, such as a client device 110 using a web client 106. The web client 106 may be in communication with the network-based publisher 102 via a web server 116. The UIs may also be associated with a client device 112 using a programmatic client 108, such as a client application. It can be appreciated in various embodiments the client devices 110, 112 may be associated with a buyer, a seller, a third party electronic commerce platform, a payment service provider, or a shipping service provider, each in communication with the network-based publisher 102 and optionally each other. The buyers and sellers may be any one of individuals, merchants, or service providers, among other things. The client devices 110 and 112 may comprise a mobile phone, desktop computer, laptop, or any other communication device that a user may use to access the network-based publisher 102.

Turning specifically to the network-based publisher 102, an application program interface (API) server 114 and a web server 116 are coupled to, and provide programmatic and web interfaces respectively to, one or more application servers 118. The application servers 118 host one or more publication application(s) of publication system 120 and one or more payment systems 122. The application server(s) 118 are, in turn, shown to be coupled to one or more database server(s) 124 that facilitate access to one or more database(s) 126.

In one embodiment, the web server 116 and the API server 114 communicate and receive data pertaining to products, listings, transactions, social network commentary and feedback, among other things, via various user input tools. For example, the web server 116 may send and receive data to and from a toolbar or webpage on a browser application (e.g., web client 106) operating on a client device (e.g., client device 110). The API server 114 may send and receive data to and from an application (e.g., client application 108) running on another client device (e.g., client device 112).

The publication system 120 publishes content on a network (e.g., the Internet). As such, the publication system 120 provides a number of publication and marketplace functions and services to users that access the network-based publisher 102. For example, the publication application(s) of publication system 120 may provide a number of services and functions to users for listing goods and/or services for sale, facilitating transactions, and reviewing and providing feedback about transactions and associated users. Additionally, the publication application(s) of publication system 120 may track and store data and metadata relating to products, listings, transactions, and user interaction with the network-based publisher 102. The publication application(s) of publication system 120 may aggregate the tracked data and metadata to perform data mining to identify trends or patterns in the data. While the publication system 120 may be discussed in terms of a marketplace environment, it may be noted that the publication system 120 may be associated with a non-marketplace environment.

The payment system 122 provides a number of payment services and functions to users. The payment system 122 allows users to accumulate value (e.g., in a commercial currency, such as the U.S. dollar, or a proprietary currency, such as “points”) in accounts, and then later to redeem the accumulated value for products (e.g., goods or services) that are made available via the publication system 120. The payment system 122 also facilitates payments from a payment mechanism (e.g., a bank account, PayPal account, or credit card) for purchases of items via the network-based marketplace. While the publication system 120 and the payment system 122 are shown in FIG. 1 to both form part of the network-based publisher 102, it will be appreciated that, in alternative embodiments, the payment system 122 may form part of a payment service that may be separate and distinct from the network-based publisher 102.

### Example Notification Modules

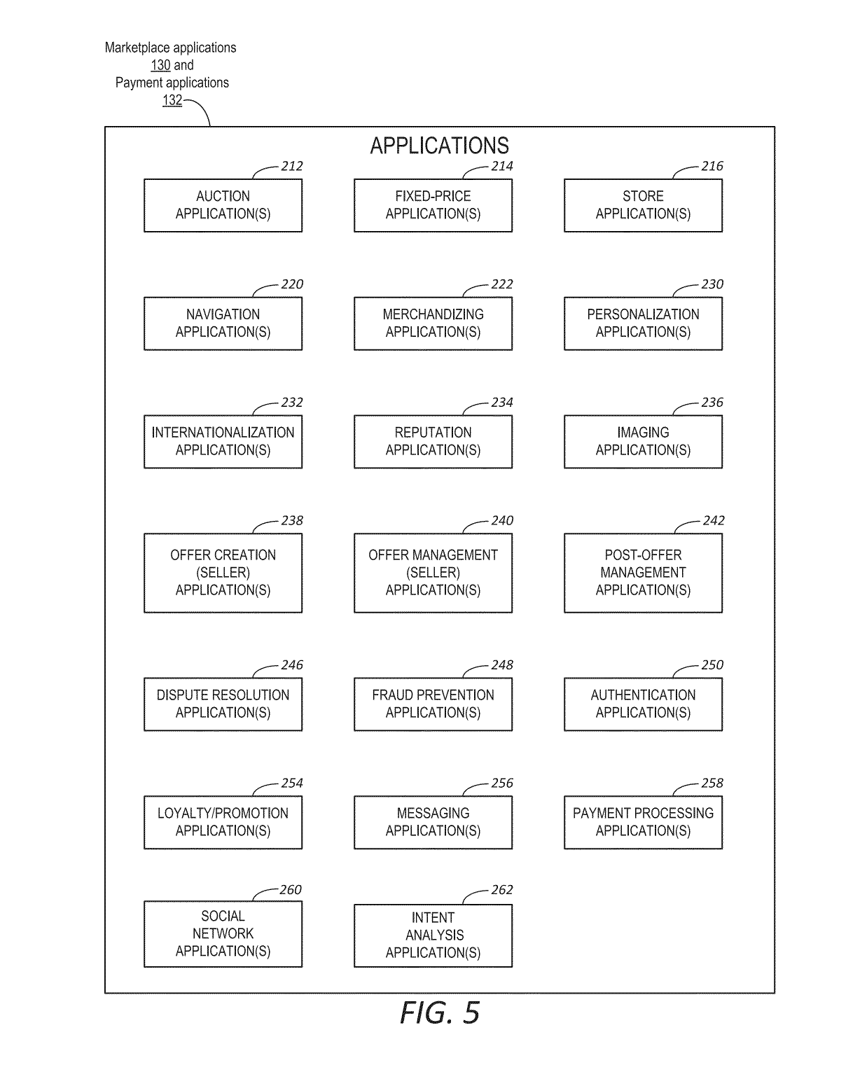

FIG. 5 illustrates a block diagram showing applications of application server(s) that are part of the network system 101, in an example embodiment. In this embodiment, the publication system 120, and the payment system 120 may be hosted by the application server(s) 118 of the network system 101. The publication system 120 and the payment system 122 may be hosted on dedicated or shared server machines (not shown) that are communicatively coupled to enable communications between server machines. The applications themselves may be communicatively coupled (e.g., via appropriate interfaces) to each other and to various data sources, so as to allow information to be passed between the applications or so as to allow the applications to share and access common data.

The publication system 120 are shown to include at least one or more auction application(s) 212 which support auction-format listing and price setting mechanisms (e.g., English, Dutch, Vickrey, Chinese, Double, Reverse auctions etc.). The auction application(s) 212 may also provide a number of features in support of such auction-format listings, such as a reserve price feature whereby a seller may specify a reserve price in connection with a listing and a proxy-bidding feature whereby a bidder may invoke automated proxy bidding. The auction-format offer in any format may be published in any virtual or physical marketplace medium and may be considered the point of sale for the commerce transaction between a seller and a buyer (or two users).

One or more fixed-price application(s) 214 support fixed-price listing formats (e.g., the traditional classified advertisement-type listing or a catalogue listing) and buyout-type listings. Specifically, buyout-type listings (e.g., including the Buy-It-Now® (BIN) technology developed by eBay Inc., of San Jose, Calif.) may be offered in conjunction with auction-format listings, and allow a buyer to purchase goods or services, which are also being offered for sale via an auction, for a fixed-price that may be typically higher than the starting price of the auction.

The application(s) of the application server(s) 118 may include one or more store application(s) 216 that allow a seller to group listings within a “virtual” store. The virtual store may be branded and otherwise personalized by and for the seller. Such a virtual store may also offer promotions, incentives and features that are specific and personalized to a relevant seller.

Navigation of the online marketplace may be facilitated by one or more navigation application(s) 220. For example, a search application as an example of a navigation application) may enable key word searches of listings published via the network-based publisher 102. A browse application may allow users to browse various category, catalogue, or inventory data structures according to which listings may be classified within the network-based publisher 102. Various other navigation applications may be provided to supplement the search and browsing applications.

Merchandizing application(s) 222 support various merchandising functions that are made available to sellers to enable sellers to increase sales via the network-based publisher 102. The merchandizing application(s) 222 also operate the various merchandising features that may be invoked by sellers, and may monitor and track the success of merchandising strategies employed by sellers.

Personalization application(s) 230 allow users of the network-based publisher 102 to personalize various aspects of their interactions with the network-based publisher 102. For example, a user may, utilizing an appropriate personalization application 230, create a personalized reference page at which information regarding transactions to which the user may be (or has been) a party may be viewed. Further, the personalization application(s) 230 may enable a third party to personalize products and other aspects of their interactions with the network-based publisher 102 and other parties, or to provide other information, such as relevant business information about themselves.

The publication system 120 may include one or more internationalization application(s) 232. In one embodiment, the network-based publisher 102 may support a number of marketplaces that are customized, for example, for specific geographic regions. A version of the network-based publisher 102 may be customized fir the United Kingdom, whereas another version of the network-based publisher 102 may be customized for the United States. Each of these versions may operate as an independent marketplace, or may be customized (or internationalized) presentations of a common underlying marketplace. The network-based publisher 102 may accordingly include a number of internationalization application(s) 232 that customize information (and/or the presentation of information) by the network-based publisher 102 according to predetermined criteria (e.g., geographic, demographic or marketplace criteria). For example, the internationalization application(s) 232 may be used to support the customization of information for a number of regional websites that are operated by the network-based publisher 102 and that are accessible via respective web servers.

Reputation application(s) 234 allow users that transact, utilizing the network-based publisher 102, to establish, build and maintain reputations, which may be made available and published to potential trading partners. Consider that where, for example, the network-based publisher 102 supports person-to-person trading, users may otherwise have no history or other reference information whereby the trustworthiness and credibility of potential trading partners may be assessed. The reputation application(s) 234 allow a user, for example through feedback provided by other transaction partners, to establish a reputation within the network-based publisher 102 over time. Other potential trading partners may then reference such a reputation for the purposes of assessing credibility and trustworthiness.

In order to make listings, available via the network-based publisher 102, as visually informing and attractive as possible, the publication system 120 may include one or more imaging application(s) 236 utilizing which users may upload images for inclusion within listings. An imaging application 236 also operates to incorporate images within viewed listings. The imaging application(s) 236 may also support one or more promotional features, such as image galleries that are presented to potential buyers. For example, sellers may generally pay an additional fee to have an image included within a gallery of images for promoted items.

The publication system 120 may include one or more offer creation application(s) 238. The over creation application(s) 238 allow sellers conveniently to author products pertaining to goods or services that they wish to transact via the network-based publisher 102. Offer management application(s) 240 allow sellers to manage offers, such as goods, services, or donation opportunities. Specifically, where a particular seller has authored and/or published a large number of products, the management of such products may present a challenge. The offer management application(s) 240 provide a number of features (e.g., auto-reproduce, inventory level monitors, etc.) to assist the seller in managing such products. One or more post-offer management application(s) 242 also assist sellers with a number of activities that typically occur post-offer. For example, upon completion of an auction facilitated by one or more auction application(s) 212, a seller may wish to leave feedback regarding a particular buyer. To this end, a post-offer management application 242 may provide an interface to one or more reputation application(s) 234, so as to allow the seller conveniently to provide feedback regarding multiple buyers to the reputation application(s) 234.

The dispute resolution application(s) 246 may provide mechanisms whereby disputes arising between transacting parties may be resolved. For example, the dispute resolution application(s) 246 may provide guided procedures whereby the parties are guided through a number of steps in an attempt to settle a dispute. In the event that the dispute cannot be settled via the guided procedures, the dispute may be escalated to a mediator or arbitrator.

The fraud prevention application(s) 248 may implement various fraud detection and prevention mechanisms to reduce the occurrence of fraud within the network-based publisher 102. The fraud prevention application(s) may prevent fraud with respect to the third party and/or the client user in relation to any part of the request, payment, information flows and/or request fulfillment. Fraud may occur with respect to unauthorized use of financial instruments, non-delivery of goods, and abuse of personal information.

Authentication application(s) 250 may verify the identity of a user, and may be used in conjunction with the fraud prevention application(s) 248. The user may be requested to submit verification of identity, an identifier upon making the purchase request, for example. Verification may be made by a code entered by the user, a cookie retrieved from the device, a phone number/identification pair, a username/password pair, handwriting, and/or biometric methods, such as voice data, face data, iris data, finger print data, and hand data. In some embodiments, the user may not be permitted to login without appropriate authentication. The system (e.g., the FSP) may automatically recognize the user, based upon the particular network-based device used and a retrieved cookie, for example.

The network-based publisher 102 itself, or one or more parties that transact via the network-based publisher 102, may operate loyalty programs and other types of promotions that are supported by one or more loyalty/promotions application(s) 254. For example, a buyer/client user may earn loyalty or promotions points for each transaction established and/or concluded with a particular seller/third party, and may be offered a reward for which accumulated loyalty points can be redeemed.

The application server(s) 118 may include messaging application(s) 256. The messaging application(s) 256 are responsible for the generation and delivery of messages to client users and third parties of the network-based publisher 102. Information in these messages may be pertinent to services offered by, and activities performed via, the payment system 120. Such messages, for example, advise client users regarding the status of products (e.g., providing “out of stock” or “outbid” notices to client users) or payment status (e.g., providing invoice for payment, Notification of a Payment Received, delivery status, invoice notices). Third parties may be notified of a product order, payment confirmation and/or shipment information. Respective messaging application(s) 256 may utilize any one of a number of message delivery networks and platforms to deliver messages to users. For example, messaging application(s) 256 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

The publication system 120 may include one or more payment processing application(s) 258. The payment processing application(s) 258 may receive electronic invoices from the merchants and may receive payments associated with the electronic invoices. The payment system 120 may also make use of functions performed by some applications included in the publication system 120. The publication system 120 may include one or more social network application(s) 260.

The publication system 120 may also include one or more intent analysis application(s) 262, which may viewed as the widget alluded to above, and which may be used for determining user intent based on query activities as discussed broadly above. For example, the intent analysis application(s) 262 may track arbitrary events like user page views, user clicks on links, track form behavior, and mouse behavior such as item customization dropdown lists, image gallery views, and page scrolling. Application(s) 262 may also track time between user actions. Seller performance may also be tracked, such as by tracking feedback count, feedback rate, and rating of sellers, such as top rated sellers. Item popularity may also be tracked by intent analyser application(s) 262, such as the number of item watches, the number of item views, the sold count of an item, and the price or price variation of an item over time. The intent analysis application(s) 262 may collect such data as UBI events and UBI sessions, and may employ tracking techniques such as asynchronous tracking, and a good caching mechanism. A ranking algorithm, such as that discussed below, may then be used to rank the results of the analysis, such as by defining factors, estimating a weight for each factor and then presenting a number of ranked items to the user.

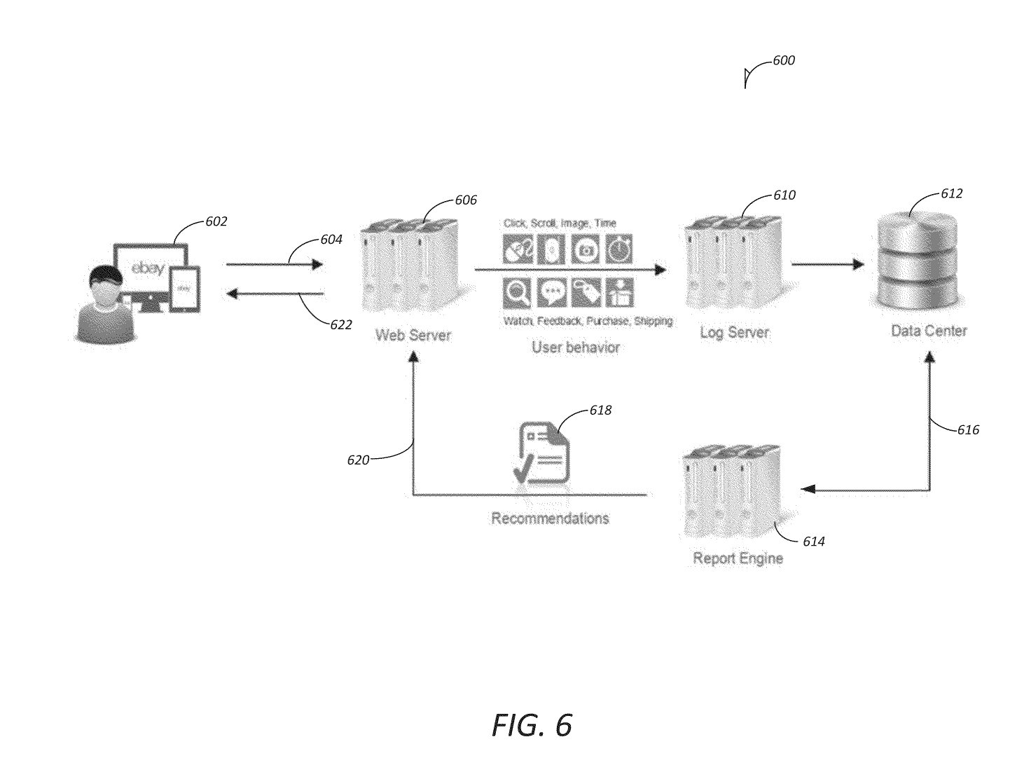

FIG. 6 is a flow chart illustrating the data flow of an embodiment. A user at a client device 602 (which may be the same as client device 110 of FIG. 4) provides query data over connection 604 (which may be a connection via a network such as the Internet) to web server 606. Web server 606 may in one embodiment be the web server 116 of FIG. 4. The log server 610, via the intent analysis application(s) 262 discussed generally above and in more detail below, may receive, over a period of time, user behavior data 608 which may be that discussed above. Web server 610 may be similar to database server(s) 124 of FIG. 4, with the processing capability discussed below. This user behavior data 608, when operated on by the ranking algorithm discussed below, may provide ranked item suggestions to data center 612 which may include database(s) 126 of FIG. 4. Report Engine 614 may construct recommendations 618 which may be provided to the web server 606 for providing to client device 602 via connection 622 which, like connection 604, may be via a network such as the Internet.

Operation of web server 116 and log server 601 may be generally described as follows. Arbitrary events such as those discussed above can be captured and collected by one or more browser support JavaScript tracking components. The algorithm employed may be similar to a Google™ Analytics platform. A piece of JavaScript snippet may be automatically rendered into web pages and several JavaScript files can be loaded into the browser to activate tracking. For example: if a user puts his or her mouse onto one of the item pictures, the “zoom in” event on the DOM image element <IMG> can be triggered. A JavaScript call back function previously applied on this “zoom in” event, will wrap the useful information into a standard JSON object based on a given protocol:

```
{
  GUID: USER21234,
  SESSION_ID: ALRDgPmH1Gu_4B95j,
  EVENT_TYPE: ARBITRARY,
  EVENT_ID: ZOOM_IN,
  TIMESTAMP: Fri, 16 Aug 2013 21:56:24 GMT
}
```

and send the information back to server, such as log server 610, for later analysis. A server data processing component may then translate these JSON data into UBI events and UBI sessions. A ranking prediction model may consume the processed UBI data based on the user's request. In order to avoid analytic code that may slow the site down, asynchronous scripts may be load and leverage browser caching. In addition, events data may be cached at the client side and be submitted to the server side once in a while, or at predetermined periods, to avoid frequent data exchange.

The intent analysis application(s) 262 may also track time between user actions. The intent analysis application(s) may also track seller performance, such as feedback count, feedback rate, and rating of sellers, such as top rated sellers or power seller, as briefly discussed above. Seller information will usually change as time goes on. When a user views an item, the information may be recorded in a data warehouse as a snapshot, for example at the end of a user session. These records will be considered as factors to support the ranking algorithm discussed below. If a user shows interest in two similar items sold by different sellers, seller performance data may make the difference in the ranking of the two items. Records may be structured as below, Since the feedback rating of two different sellers is 99.9% and 97%, and feedback count is 10000 and 200, respectively, namely SELLER_ID 1 has higher performance and his/her items would be ranked first. There will be more complicated cases, for example, seller A has higher rate but lower feedback count and seller B has higher feedback count but lower rate. The ranking algorithm which will be discussed below will consider feedback rate, feedback count and other seller performance metrics together to make the final ranking,

| SELLER_ID | ITEM_ID | FEEDBACK_RATE | FEEDBACK_COUNT | . . . | SNAPSHOT_DATE |
|---|---|---|---|---|---|
| 1 | 11 | 99.9% | 10000 | . . . | Sep 02 18:59:19 2013 |
| 2 | 22 | 97% | 200 | . . . | Sep 02 18:58:17 2013 |

Item popularity may also be tracked by the intent analyser application(s) 262, such as the number of item watches, the number of item views, the sold count of an item, and the price or price variation over time, as briefly discussed above. These item popularity data may be recorded in data warehouse in form of daily snapshot, and they will also be considered as factors to support a ranking algorithm, below.

A ranking algorithm may then be used to rank the results of the analysis, such as by defining factors, estimating a weight for each factor and then presenting a number of ranked items to the user. The ranking of items shown to the end user is based on current behavior data and may utilize a Boosted Ranking Model (BRM) introduced by Kevin Dela Rosa, Vangelis Metsis, and Vassilis Athitsos in 2011. The algorithm is domain independent and applicable to the general ranking of items where the ranking criteria are not fixed and are not known a priori. The basis of this algorithm is composed of three well established methods, including adaBoost, nearest neighbor retrieval, and nearest neighbor classification. Details of the algorithm may be seen in the article Boosted Rank Models: A Unifying Framework for Ranking Predictions by the foregoing authors, located at http://www.cs.cmu.edu/˜kdelaros/kais2011.pdf. The BRM method may be used because it does not learn a single ranking function, but utilizes a global ranking model that produces a customized ranking function for any set of ranking criteria. This may be viewed as critical since the ranking methods will be customized to each user. In addition, BRM is capable of performing training off line, if desired, which may reduce the need for online resources. As one example, define U to be a finite set of items listed on a publication system, such as eBay, as viewed by users, and let Q be a finite set of active users in the eBay domain. Assume there exists a single correct ranking model Rₜᵣᵤₑ that specifies a “true” rank Rₜᵣᵤₑ(Q,U) for every item U given any user Q. The algorithm's goal is to build a system whose rankings are as close as possible, or as close as practical, to the rankings produced by Rₜᵣᵤₑ through training data. One example of using training data might be collecting time spent on viewing an item, number of views, and the whether or not the item was placed on the watch list.

$$Assume {S}^{I} ( Q , U ) = \{ \begin{matrix}0 , if the user has not clicked on the item \\ mean clicks of U by users in Q ( I , {S}_{true} ( Q , M ) ) , otherwise\end{matrix}$$

In other words, if user Q has not viewed item I, then S^{I}(Q,U)=0. If user Q has viewed item I with the number of views n=Sₜᵣᵤₑ(Q,M) then we find the set Q(M,n) of all users who also had viewed item I, and return the average number of views for the item. Since BRM uses boosting, one assumption is that an input of scoring models will be pre-defined. One statement of the algorithm may as follows:
1. Define binary classifier S for each scoring model R and estimate error rate of each model based on training data. The error rates are estimated by triples (Q, A, B), whether Rtrue(Q, A)<Rtrue(Q, B) or Rtrue(Q, A)>Rtrue(Q, B);
2. Run adaBoost, using provided training sets and binary classifier S into an optimized binary classifier Ŝₒₚₜ;
3. Define a scoring model Sopt using binary classifier Ŝₒₚₜ; and
4. Using Sopt, define the corresponding ranking model Ropt.
   The report engine 614 of FIG. 6 may then construct item recommendations 618 which may then be provided to client device 602 as discussed above,

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

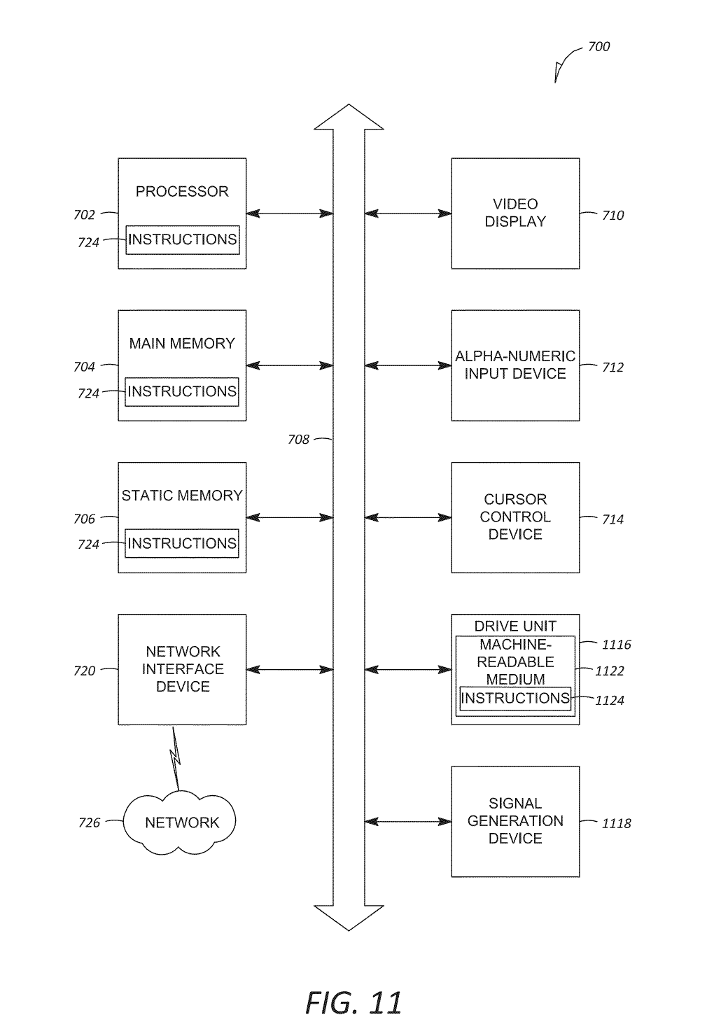

FIG. 7 is a block diagram of machine in the example form of a computer system 700 within which there may be executed instructions 724 for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal displays (LCD) or a cathode ray tube (CRT)). The computer system 700 also includes an alphanumeric input device 712 (e.g., a keyboard), a cursor control device 714 (e.g., user interface (UI) navigation device or computer mouse), a disk drive unit 716, a signal generation device 718 (e.g., a speaker) and a network interface device 720.

### Machine-Readable Medium

The disk drive unit 716 includes a machine-readable medium 722 on which is stored one or more sets of data structures and instructions 724 (e.g., software) embodying or used by any one or more of the methodologies or functions described herein. The instructions 724 may also reside, completely or at least partially, within the main memory 704, static memory 706, and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media. (e.g., a centralized or distributed database, and/or associated caches and servers) that store the one or more instructions 724 or data structures. The term “machine-readable medium” shall also be taken to include any tangible medium that is capable of storing, encoding or carrying instructions for execution by the machine and that cause the machine to perform any one or more of the methodologies of the embodiments of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks. A “machine-readable storage medium” shall also include devices that may be interpreted as transitory, such as register memory, processor cache, and RAM, among others. The definitions provided herein of machine-readable medium and machine-readable storage medium are applicable even if the machine-readable medium is further characterized as being “non-transitory.” For example, any addition of “non-transitory,” such as non-transitory machine-readable storage medium, is intended to continue to encompass register memory, processor cache and RAM, among other memory devices.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a LAN, a WAN, the Internet, mobile telephone networks, Plain Old Telephone (POTS) networks, and wireless data networks (e.g., Wi-fi and IMAX networks). The term “transmission medium” shall be taken to include any intangible medium that is capable of storing, encoding or carrying instructions for execution by the machine, and includes digital or analog communications signals or other intangible media to facilitate communication of such software.

Although the present inventive subject matter has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein, Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method of determining user intent based on current user query behavior comprising:
receiving from a client machine a plurality of signals indicating current user behavior when querying for items;
tracking events of current user behavior indicated by the signals; and
recommending items that the events indicate are items intended by the current user behavior.

2. The method of claim 1, further comprising tracking seller performance and recommending items that the events and the seller performance indicate are items intended by the user.

3. The method of claim 1 wherein the behavior includes at least one of user page views, user clicks on links, and form behavior.

4. The method of claim 1 wherein the behavior comprises mouse behavior including one of item customization dropdown lists, image gallery views, and page scrolling.

5. The method of claim 1 wherein the recommended items are ranked by a ranking algorithm.

6. The method of claim 1 including rendering first script code into web pages and loading second script code into a browser to activate tracking.

7. The method of claim 5 wherein the algorithm comprises a boosted rank model algorithm that customizes ranking to each of a plurality of client machines.

8. The method of claim 7 wherein the ranking algorithm comprises:
defining a binary classifier S for each scoring model R and estimating error rate of each scoring model based on training data, wherein error rates are estimated by triples (Q, A, B), whether Rtrue(Q, A)<Rtrue(Q, B) or Rtrue(Q, A)>Rtrue(Q, B);
running adaBoost, using provided training sets and binary classifier S into an optimized binary classifier Sopt;
defining a scoring model Sopt; and
using Sopt, defining the corresponding ranking model Ropt.

9. A computer-readable hardware storage device having embedded therein a set of instructions which, when executed by one or more processors of a computer, causes the computer to execute the following operations:
receiving from a client machine a plurality of signals indicating current user behavior when querying for items;
tracking events of current user behavior indicated by the signals; and
recommending items that the events indicate are items intended by the current user behavior.

10. The computer-readable hardware storage device of claim 9, the operations further comprising tracking seller performance and recommending items that the events and the seller performance indicate are items intended by the user.

11. The computer-readable hardware storage device of claim 9, the operations including ranking the recommended items by a ranking algorithm.

12. The computer-readable hardware storage device of claim 11 wherein the algorithm comprises a boosted rank model algorithm that customizes ranking to each of a plurality of client machines.

13. The computer-readable hardware storage device of claim 12 wherein the ranking algorithm comprises:
defining a binary classifier S for each scoring model R and estimating error rate of each scoring model based on training data, wherein error rates are estimated by triples (Q, A, B), whether Rtrue(Q, A)<Rtrue(Q, B) or Rtrue(Q, A)>Rtrue(Q, B);
running adaBoost, using provided training sets and binary classifier S into an optimized binary classifier Sopt;
defining a scoring model Sopt; and
using Sopt, defining the corresponding ranking model Ropt.

14. A system of determining user intent based on current user query behavior comprising:
one or more computer processors configured to receive from a client machine a plurality of signals indicating current user behavior when querying for items;
track events of current user behavior indicated by the signals; and
recommend items that the events indicate are items intended by the current user behavior.

15. The system of claim 14, the one or more computer processors further configured to track seller performance and recommend items that the events and the seller performance indicate are items intended by the user.

16. The system of claim 14 wherein the behavior comprises mouse behavior including one of item customization dropdown lists, image gallery views, and page scrolling.

17. The method of claim 14 wherein the recommended items are ranked by a ranking algorithm.

18. The system of claim 14 the one or more computer processors further configured to render first script code into web pages and load second script code into a browser to activate tracking.

19. The method of claim 17 wherein the algorithm comprises a boosted rank model algorithm that customizes ranking to each of a plurality of client machines.

20. The method of claim 19 wherein the ranking algorithm comprises:
defining a binary classifier S for each scoring model R and estimating error rate of each scoring model based on training data, wherein error rates are estimated by triples (Q, A, B), whether Rtrue(Q, A)<Rtrue(Q, B) or Rtrue(Q, A)>Rtrue(Q, B);
running adaBoost, using provided training sets and binary classifier S into an optimized binary classifier Sopt;
defining a scoring model Sopt; and
using Sopt, defining the corresponding ranking model Ropt.
